(19) United States
(12) Patent Application Publication
(10) Pub. No.: US 2025/0058712 A1
(43) Pub. Date: Feb. 20, 2025

(54) AUGMENTED VEHICLE BLIND SPOT DETECTION WITH TRANSPARENT TRAILER

(71) Applicant: Robert Bosch GmbH, Stuttgart (DE)

(72) Inventors: Michael R. Meier, Walled Lake, MI (US); James Stephen Miller, Dexter, MI (US); Frank Peter Riggi, Brighton, MI (US); Elizabeth E. Kao, Northville, MI (US)

(21) Appl. No.: 18/452,272

(22) Filed: Aug. 18, 2023

(51) Int. Cl. B60R 1/26; B60R 25/10

(52) U.S. Cl. CPC B60R 1/26; B60R 25/1001; B60R 2021/01322; B60R 25/08; B60R 2300/301

(57) ABSTRACT

A system of object detection for a trailer. In one example, the system includes a camera configured to capture images of the trailer, where the images include an object other than the trailer. The system also includes a sensor configured to capture sensor data, a display configured to display images from the perspective of the camera, and a controller on the vehicle. The controller includes an electronic processor configured to receive the image data from the camera, receive the sensor data from the sensor, determine a blind spot, analyze the sensor data for radar data associated with the object, calculate the position of the object relative to the blind spot and the trailer, determine that the object is within the blind spot using an object detection algorithm, and in response to the determining that the object is within the blind spot, generate an augmented image.

### FIELD

Embodiments, examples, aspects, and features described herein relate to a system of vehicle blind spot detection.

A blind spot in a vehicle is an area around the vehicle that cannot be directly seen by the driver while at the controls. Blind spots exist in a wide range of vehicles, for example, in cars, buses, trucks, and agricultural equipment. In passenger vehicles and light trucks, blind spots may occur in the front of the driver, for example, when an A-pillar (also called the windshield pillar) blocks a driver's view. Often a blind spot occurs behind a driver, for example, in an area, that cannot be seen via a side-view mirror, or that is blocked from view by vehicle structures, for example, B- or C-pillars.

### SUMMARY

Many vehicles include radar systems for detecting vehicle blind spots. Additionally, many vehicles include trailer hauling capabilities. Blind spot detection systems do not always cover the additional blind spots introduced by the trailer. It would be desirable for vehicle blind spot detection systems to be augmented so that additional and modified blind spots presented when a vehicle is towing a trailer are detected. Therefore, embodiments described herein provide, among other things, systems and methods for detecting vehicle blind spots present when a vehicle tows a trailer.

Some examples provide a system of object detection for a trailer connected to a vehicle. In some instances, the system includes a camera positioned at a rear end of the vehicle, where the camera is configured to capture images of the trailer. The images include an object other than the trailer. The system also includes a sensor configured to capture sensor data about the object, and a display configured to display images from the perspective of the camera. The system also includes a controller on the vehicle. The controller includes an input/output interface, a memory, and an electronic processor configured to receive the image data from the camera, receive the sensor data from the sensor, and determine a blind spot. The controller is further configured to analyze the sensor data for radar data associated with the object, calculate the position of the object relative to the blind spot, determine that the object is within the blind spot using an object detection algorithm, and in response to the determination that the object is within the blind spot, generate an augmented image including a representation of the object for presentation by the display.

In some instances, the augmented image includes proximity information of the object relative to the trailer. The augmented image includes a visual representation of the blind spot. The augmented image may include more than one blind spot. In some examples, the augmented images include more than one object other than the trailer. In some examples, the sensor is configured to capture sensor data about more than one object. In some instances, the electronic processor is further configured to calculate the position of the more than one object relative to the blind spot and the trailer, and determine that one of the more than one object is within the blind spot using the object detection algorithm. The electronic processor may be further configured to analyze the sensor data for radar data associated with the more than one object and calculate the position of all of the more than one object relative to the blind spot and the trailer.

In some instances, the electronic processor is further configured to generate an augmented image including the more than one object for presentation by the display. In some instances, the electronic processor is further configured to generate an augmented image including all of the more than one object for presentation by the display. In some instances, the electronic processor is further configured to generate an augmented image including proximity information for the more than one object for presentation by the display. In some instances, the electronic processor is further configured to generate an augmented image including the more than one object and more than one blind spot.

Some examples provide a method of object detection for a trailer connected to a vehicle. The method includes generating, by a camera positioned at a rear end of the vehicle, images of the trailer, where the images include an object other than the trailer. The method also includes generating, by a sensor, sensor data about the object; receiving, by an electronic processor, the image data; receiving, by the electronic processor, the sensor data; and analyzing, by the electronic processor, the sensor data for radar data associated with the object. The method further includes determining, by the electronic processor, a blind spot; calculating, by the electronic processor, the position of the object relative to the blind spot and the trailer, determining, via the electronic processor, that the object is within the blind spot using an object detection algorithm, and in response to the determination that the object is within the blind spot, generating, via the electronic processor, an augmented image including a representation of the object for presentation via the display.

In some instances, the augmented image includes more than one blind spot. In some instances, the augmented images include more than one object other than the trailer, and the sensor is configured to capture sensor data about the more than one object. In some instances, the method further includes calculating, via the electronic processor, the position of the more than one object relative to the blind spot and the trailer, and determining, the electronic processor, that one of the more than one object is within the blind spot using the object detection algorithm. In some instances, the method further includes analyzing, via the electronic processor, the sensor data for radar data associated with the more than one object and calculating, via the electronic processor, the position of all of the more than one object relative to the blind spot and the trailer.

In some instances, a system of object detection for a trailer connected to a vehicle, the system includes a camera positioned at a rear end of the vehicle, the camera configured to capture images of the trailer, the images including an object other than the trailer and a sensor configured to capture sensor data about the object, the sensor data including a proximity of the object to the trailer. The system further includes a display configured to display images from the perspective of the camera, and a controller on the vehicle, the controller including an input/output interface, a memory, and an electronic processor. The electronic processor is configured to receive the image data from the camera, receive the sensor data from the sensor, determine a blind spot, and analyze the sensor data for radar data associated with the object. The electronic processor is further configured to calculate the position of the object relative to the blind spot and the trailer, determine that the object is within the blind spot using an object detection algorithm, determine if the object has exceeded a proximity threshold, and in response to the determination that the object is within the blind spot, generate an augmented image including a representation of the object for presentation via the display, and in response to the determination that the object has exceeded a proximity threshold, controlling an aspect of the vehicle.

In some instances, in response to the determination that the object has exceeded a proximity threshold, the controller displays a proximity alarm on the display. In some instances, in response to the determination that the object has exceeded a proximity threshold, the controller controls brakes of the vehicle.

Other aspects, features, examples, and embodiments will become apparent by consideration of the detailed description and accompanying drawings.

### BRIEF DESCRIPTION OF THE DRAWINGS

FIG. 1 is an illustration of a system for monitoring trailer blind spots, according to some aspects.

FIG. 2D is a representation of picture of a trailer including a trailer blind spot, according to some aspects.

FIG. 3 is an illustration of a radar detection, according to some aspects.

FIG. 4A is an illustration of an augmented display for the system of FIG. 1, according to some aspects.

FIG. 4B is an illustration of an augmented display for the system of FIG. 1, according to some aspects.

FIG. 5 is a flowchart of a process for monitoring trailer blind spots, according to some aspects.

FIG. 6 is a flowchart of a process for monitoring trailer blind spots.

### DETAILED DESCRIPTION

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

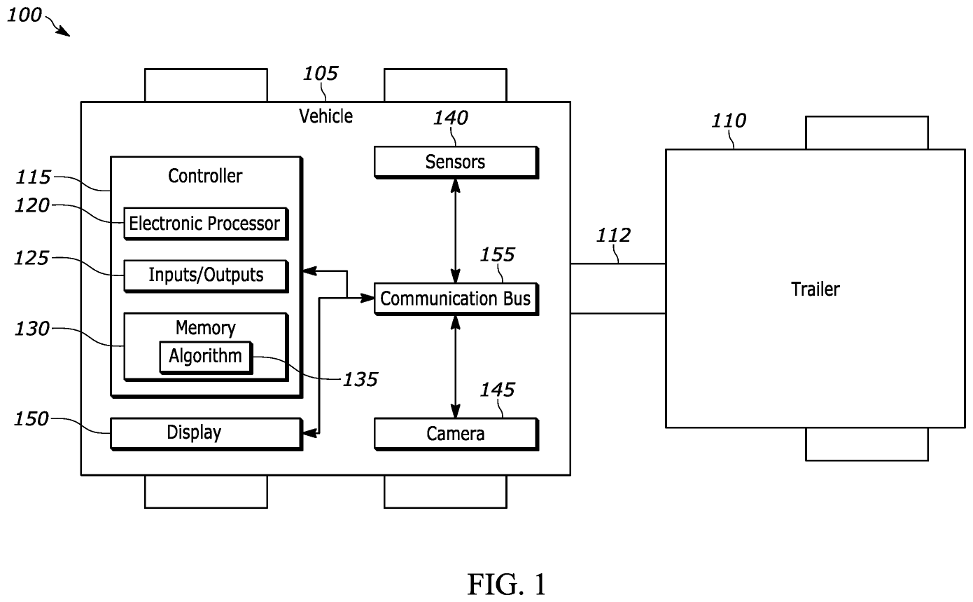

FIG. 1 illustrates a system for monitoring trailer blind spots, according to some aspects. System 100 includes a vehicle 105 and a trailer 110 attached to the vehicle 105 by a hitch 112. The vehicle 105 has an onboard a controller 115. In the example shown, the controller 115 includes an electronic processor 120, an input/output interface 125, and memory 130. In some examples, electronic processor 120 is implemented as a microprocessor with separate memory as shown, for example, the memory 130. In other examples, the electronic processor 120 may be implemented as a microcontroller (with memory 130 on the same chip). In other examples, the electronic processor 120 may be implemented using multiple processors. In addition, the electronic processor 120 may be implemented partially or entirely as, for example, a field-programmable gate array (FPGA), an applications specific integrated circuit (ASIC), and the like and the memory 130 may not be needed or be modified accordingly.

In some examples, the memory 130 includes non-transitory, computer-readable media that stores instructions that are received and executed by the electronic processor 120 to carry out method described herein. The memory 130 may include, for example, a program storage area and a data storage area. The program storage area and the data storage area may include combinations of different types of memory, for example read-only memory and random-access memory. In the example shown, the memory 130 stores software used during operation of the vehicle 105. In one specific instance, the memory 130 stores an object detection algorithm 135 (also referred to as algorithm 135).

The input/output interface 125 may include one or more input mechanisms and one or more output mechanisms, for example, general-purpose inputs/outputs (GPIOs), analog inputs, digital inputs, and the like.

In some examples, the illustrated components may be combined or divided into separate software, firmware and/or hardware. For example, instead of being located within and performed by a single electronic processor, logic and processing may be distributed among multiple electronic processors and memories. Regardless of how they are combined or divided, hardware and software components may be located on the same computing device or may be distributed among different computing devices connected by one or more networks or other suitable communication links.

The vehicle 105 also includes one or more sensors 140. Sensors 140 may include a radar sensor, a LIDAR sensor, or the like. In some examples, an individual sensor 140 includes internal processing hardware and software and the sensor 140 is configured to generate sensor data about objects detected by (or via) the sensor 140. For instance, when an object is within a sensing range of the sensor 140, the sensor may generate proximity data regarding the object. The sensor 140 may also generate other data, such as data corresponding to the size, dimensions, speed, or other discerning features of the object. The vehicle 105 also includes a camera 145 configured to capture images of the trailer 110 connected to the vehicle 105. For example, in one embodiment, the camera is mounted on the rear of the vehicle, near the trailer hitch, and is angled downward to capture a view of an area behind the vehicle. In some instances, additional cameras are mounted to the vehicle or to the trailer. The vehicle 105 also includes a display 150 configured to display images captured by (or via) the camera 145 and images augmented by the algorithm 135. A communication bus 155 electrically connects the camera 145, sensor 140, the display 150, and controller 115 to each other. In some instances, the bus is a controller area network (CAN) bus. In other instances, the bus is a FlexRay™ communications bus. In still other instances, an Ethernet network or other suitable bus is implemented.

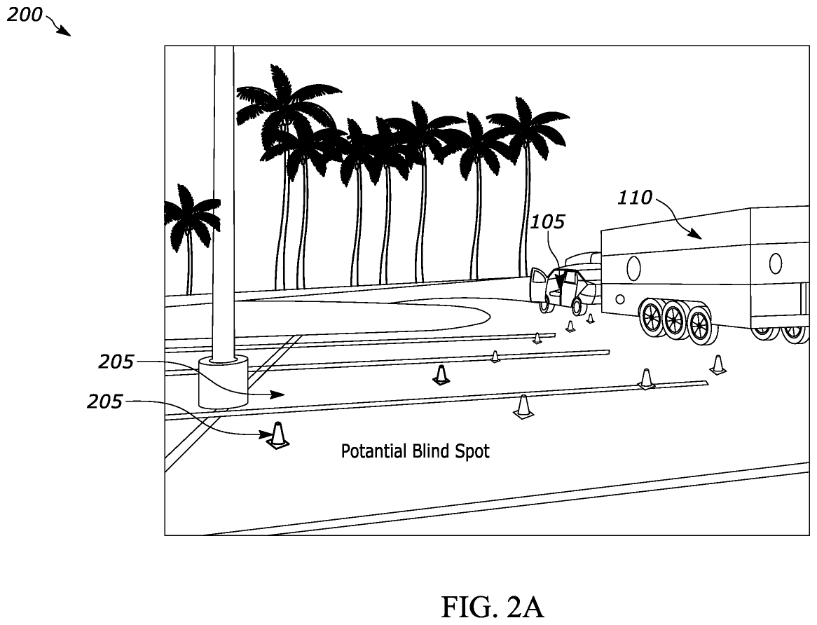

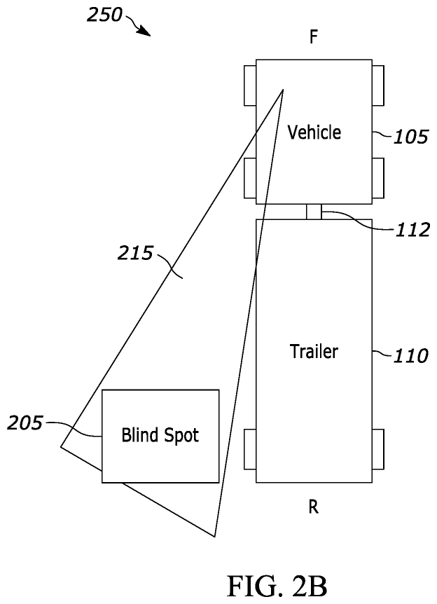

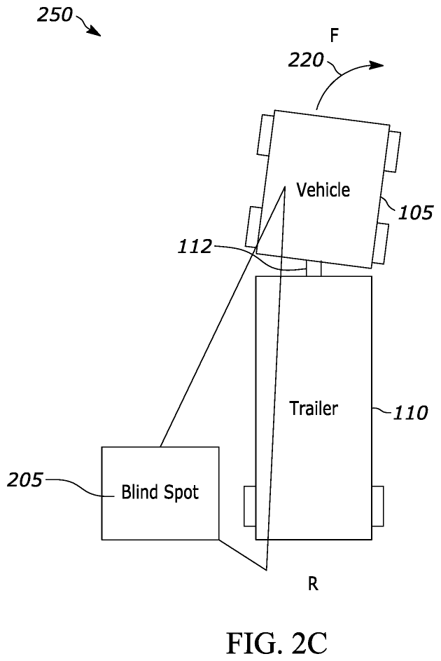

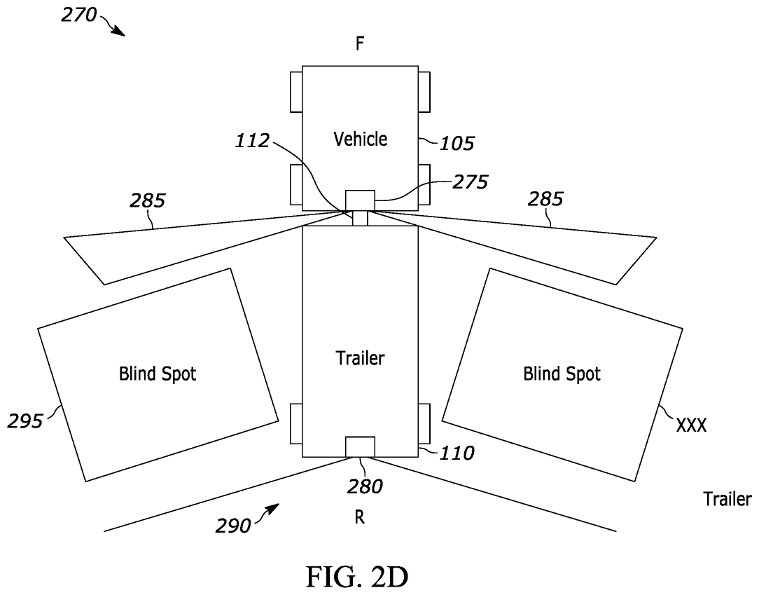

FIG. 2A is an illustration 200 of a trailer 110 connected to the vehicle 105. A blind spot 205, in this instance, an area not viewable by a driver via a side-view mirror is identified within the image. A trailer may have many blind spots, created by the size of the trailer, the position of the driver relative to the trailer, the angle of a turn of the vehicle or of the trailer, or the like. The blind spot 205 in the illustration 200 is marked via cones 210, but it should be understood that this marking is used to represent a potential blind spot that occurs when the vehicle 105 and trailer 110 are in a static position. Blind spots are dynamic when a vehicle is in motion (i.e., driven), and a particular blind spot may be larger or smaller than blind spot 205 or may occur in a number of different locations, including locations to the rear of the vehicle 105. As a vehicle traverses a terrain, potential blind spots are generated. For instance, when a vehicle makes a right turn, a blind spot 205 may occur at the rear left of the trailer. The size of the trailer may also contribute to the possibility of a blind spot. For instance, a wide trailer may obscure a greater area of vision of the driver than a narrow trailer might. Additionally, a trailer with a large load, such as a flatbed configured to haul another vehicle, may create additional blind spots. A blind spot may also occur in the front of the vehicle. For instance, a blind spot may be located in front of a vehicle with a large, elevated cabin, or in a vehicle with a work element in front of it, such as a forklift.

FIG. 2B is a top-down illustration 250 of the vehicle 105 and the trailer 110. The blind spot 205 is located to the rear-left of the trailer 110, similar to the location of the vehicle 105 and trailer in FIG. TA. A field of vision 215 is shown in the illustration 250 to signify the location of the blind spot 205. FIG. 2C illustrates the dynamic movement of a vehicle, in this case a right turn 220. As the vehicle turns to the right, the field of vision 215 of the driver is obscured by the trailer. Although FIGS. 2A-2C illustrate the blind spot from the perspective of the driver of the vehicle 105, it should be understood that blind spots may occur from additional perspectives, such as a passenger of the vehicle 105, the camera 145, sensors 140, or any other position on the vehicle 105 or the trailer 110.

FIG. 2D is a top-down illustration 270 of the vehicle 105 and the trailer 110 according to some aspects and examples. As previously mentioned, in some instances, the vehicle includes camera 145. In some examples, the camera 145 is a first camera 275 located near the hitch 112. The vehicle 105 may include a second camera 280 located at a rear of the trailer 110. The first camera 275 may be a back-up camera, a rear facing dashcam, a security camera, or the like. The first camera 275 includes a field of view 285. The field of view 285 generally extends rearward from the hitch in a direction opposite from the front of the vehicle 105. In FIG. 2D the horizontal extent of the field of view is shown. In some examples, the first camera 275 field of view 285 is limited due to the presence of trailer 10 and extends in two relatively limited areas or fields of limited degrees. In instances where the vehicle 105 is disconnected from the trailer 110, the field of view 285 may extend up to 180 degrees (in a horizontal plane).

In some instances, the trailer 110 also includes a second camera 280. The second camera 280 may be configured similar to the first camera 275, and also includes a field of view 290. The field of view 290 generally extends rearward from the trailer 110, and in some examples, extends up to 180 degrees. When the trailer 110 is hitched to the vehicle 105, such as is shown in top-down illustration 270, the field of view 285 of the first camera 275 may be partially obstructed by portions of the trailer 110. This obstruction creates blind spots, such as blind spot 295. Similar to blind spot 205 as previously described, objects within the blind spot 295 are not visible by the cameras (275, 280) and may not be visible by the driver. As previously described, the blind spots may be dynamic and change size, shape, or location depending, for example, on the movement of the vehicle 105 and the trailer 110.

Images captured by the cameras (145, 275, 280) are displayed on the display 150 of the vehicle. For instance, when the trailer 110 is not connected to the vehicle 105, the camera 275 may display a rear-facing view of objects behind the vehicle 105. When the trailer 110 is connected, this rear-facing view is obstructed by the trailer 110, creating the previously described blind spot 295. Systems and methods described herein help, among other things, improve a driver's awareness of objects within these blind spots representing objects detected in the blind spots to the driver. In some examples, the images captured by the first camera 275 and the images captured by the second camera 280 are augmented with each other, to form a single image to be displayed on the display 150.

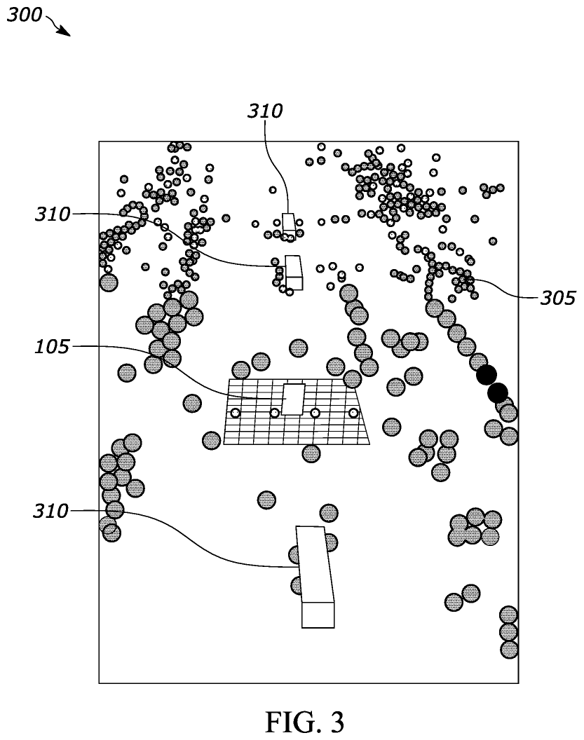

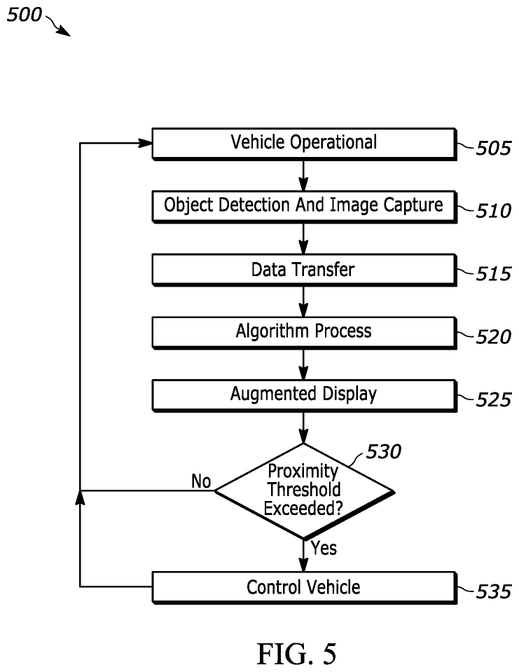

FIG. 3 is an illustration of a radar map 300 generated by one of the sensors 140 when that sensor is a radar sensor. The radar map 300 include representations of objects around the vehicle 105. The sensor 140 may (alone or in connection with other processing resources) detect various objects around the vehicle and plot them on the radar map 300 at locations. The sensor 140 then generates sensor data, also referred to as radar data 305, to be processed by (or via) the electronic processor 120 and analyzed by the algorithm 135. The algorithm 135 then determines if the radar data 305 is an object, such as object 310 displayed on the radar map 300. The sensors 140 are also configured to detect a proximity of the object 310 to the trailer 110 and the vehicle 105. In some examples, the sensors 140 are configured to target neighboring driving lanes for the vehicle 105. For example, the sensors may be configured to target a nearest driving lane to the left and to the right of the vehicle 105. In some instances, one sensor is configured to monitor one lane while another sensor is configured to monitor another lane. Some sensors are configured to monitor the lane in which the vehicle 105 currently occupies. For example, object 310 is a vehicle detected by the sensors 140 and classified as a vehicle by the algorithm 135. The algorithm 135 may classify the object 310 as an object other than a vehicle. In such cases, the augmented image includes a different representation for that object. Objects detected by the camera may include fences, cones, curbs, other vehicles, road surfaces, or any other object. Each type of object may include a unique augmented representation, or certain objects may include a classification of objects. For instance, pedestrians, bicyclists, and animals may be one classification of objects. Another type of classification of object may include stationary objects, such as lamp posts, street lights, or the light. The process by which the algorithm 135 classifies objects and augments images captured by the camera 145 is described below and illustrated in FIG. 5.

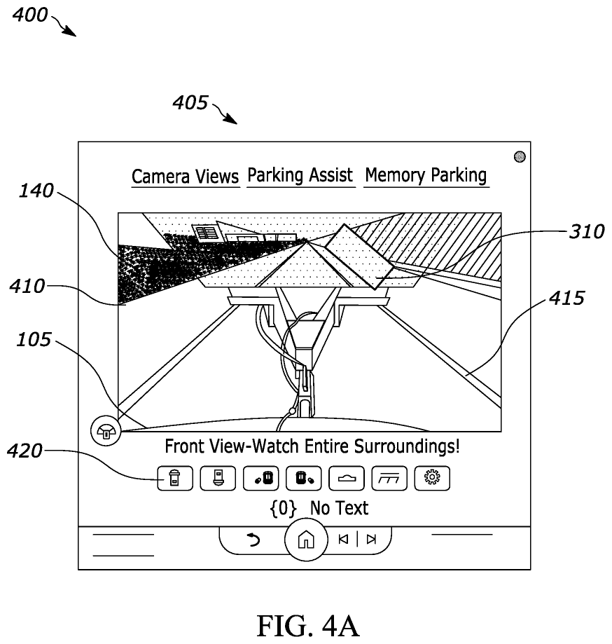

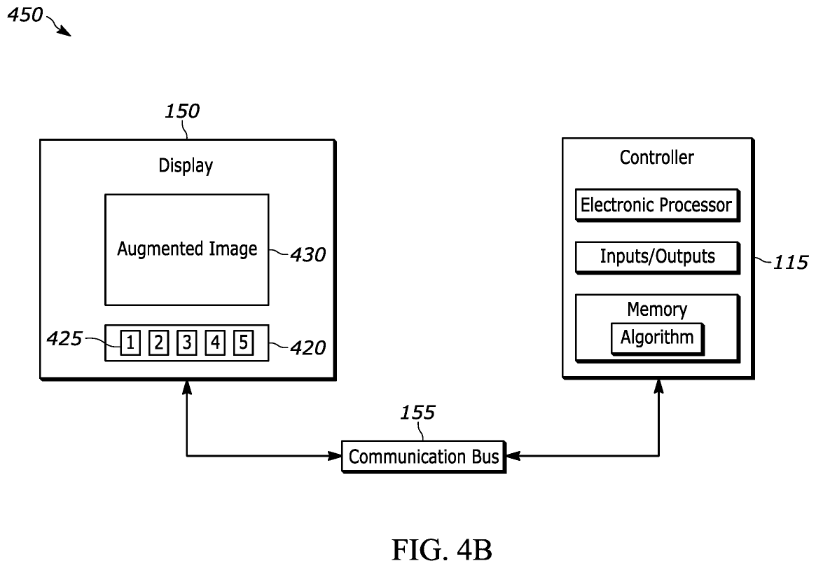

FIG. 4A is an illustration of an augmented display for the system of monitoring trailer blind spots, according to some aspects. The illustration 400 includes a camera view 405 of an image from the camera 145. As previously described, the system may combine multiple image captures from more than one camera (e.g., cameras 145, 275, 280) to display. The images captured may be overlayed, displayed side-by-side, or otherwise presented. The image 410 includes the vehicle 105, the trailer 110, the road 415, and has been augmented by the algorithm 135 to include the object 310 obscured by the trailer. As seen in the image 410, the trailer 110 would normally obscure a visual of the object 310. As the vehicle travels down the road 415, every frame captured by the camera 145 is processed by the electronic processor 120 and analyzed by the algorithm 135 in order to generate the augmented image. Additionally, sensors 140 generate radar data including information about detected objects, and this radar data is used to determine the position, velocity and size of the detected objects.

The algorithm processes the objects 310 along with the location of the vehicle 105 and the trailer 110 and determines if the object 310 are obscured by the trailer 110. If the algorithm 135 determines that the object 310 is obscured, the algorithm 135 augments the image. In some instances, objects 310 are classified in order to generate the augmented overlay for the blind spot region. For instance, two different objects may be classified similarly (e.g., classified as a vehicle) in order to be displayed on the augmented image. The augmented image may include a virtual object, such as a green cube, that represents the object 310 and illustrates that the object 310 is obscured from vision. In some examples, the image may include a picture of the object 310 superimposed over the location of the blind spot 205. In some examples, the augmented image includes a warning that illustrates the location of all possible blind spots. The augmented image is then displayed by display 150.

In some examples, the augmented image may include symbols, generic 3D models of objects, or a detailed model of an objected generated by artificial intelligence. For instance, a generative AI model may generate a vehicle image based upon the object classification as a vehicle. The generative AI model may be based upon one or more images captured by the cameras (145, 275, 280) in combination with the radar data generated by the sensors 140. The generative AI model may be based on images of the object (before it entered the blind spot) and created using techniques such as NeRF (Neural Radiance Fields). In some instances, the generative AI model may be based on trained networks using radar sensor input such as radar spectral data or high accuracy reflection locations. These can be used to directly generate the 3-D model, or may be used to classify the object with the use of a pre-stored 3-D model for each object classification.

In some examples, the object 310 detected by the sensor 140 may be correlated with the object 310 seen by the camera 145 outside of the blind spot, and then subsequently tracked as the object 310 enters the blind spot. In some instances, this detection in the image may be performed by the cameras (145, 275) when the vehicle 105 overtakes the object 310 while the object 310 is in an adjacent lane. In some instances, this may be performed by the camera 280 that is mounted on the rear of the trailer when a vehicle is approaching from the rear. Static objects in the captured by the cameras (145, 275, 280) or sensors 140, such as road markings, parked vehicles, vegetation, or the like, may be rendered in the augmented image based on the driven distance. For instance, objects that are closer to the vehicle 105 may appear larger than objects that are farther from the vehicle 105. The rendering and augmentation of static objects does not require the use of models, as is done for dynamic objects, but instead uses the aligned video image with a transformation to account for increased distance. The size, orientation, and pose of the 3-D model projected into the image may depend on the distance measurement and estimated size of the object 310. In some instances, these calculations are performed during the classification process. In other instances, they are performed by the algorithm as detailed herein.

Additionally visible in the illustration 400 are controls for the display 150. The display 150 may include an interface 420 for controlling the camera 145 or an aspect of the display 150. In some examples, the display 150 includes options to cycle through multiple cameras, turn on or off the augmented images, expand or contract the image, change the field of view, or the like. In some examples, the display 150 is one portion of the onboard vehicle computer and may be toggled on or off. In other examples, the display 150 is configured as a separate monitor and is dedicated only to displaying the augmented images.

FIG. 4B is an illustration of the augmented display for the system of monitoring trailer blind spots as previously described. The illustration 450 includes the display 150 of the vehicle 105 connected to the controller 115 via the communication bus 155. As previously described, the display 150 may include an interface 420 with a plurality of buttons 425 for selecting various options for the display 150. The illustration includes the augmented image 430 show on the display 150.

FIG. 5 is a flowchart of a process for monitoring trailer blind spots, according to some aspects. The process 500 begins at step 505, with the vehicle 105 towing the trailer 110. The process continues to step 510, where the sensors 140 captures radar data 305, and the camera 145 attached to the vehicle records an image 410 of the trailer 110. In some instances, radar data 305 may include radar spectral data in addition to location data. Additionally, the relative speed of the vehicle may be detected by the sensors 140. In some examples, at step 505, other cameras capture different images from alternative perspectives, such as images captured from cameras 275 and/or 280. At step 515 of the process 500, the camera 145 sends the image 410 to the controller 115, and the sensors 140 sends the radar data 305 to the controller 115.

The process continues to step 520, where the electronic processor 120 of the controller 115 runs the algorithm 135. Every image captured by the camera 145, and all and the radar data 305 captured by sensors 140, are run through the algorithm 135. The algorithm 135 correlates the radar data 305 with the image. All objects 310 detected by the sensors 140 are analyzed by the algorithm 135. The algorithm 135 then superimposes a representation of the object 310 that are obscured by the trailer 110 onto the image 410, thereby generating an augmented image that includes the object 310 that are located within the blind spot. The augmented image is then displayed on the display 150. In some instances, the augmented image also includes proximity information. For example, the sensors 140 detect the proximity of an object 310 and include proximity information within the radar data 305 sent to the controller 115. The controller may then calculate the distance between the object 310 and the vehicle 105 or the trailer 110. This proximity information may be displayed on the display 150 along with the augmented image. The proximity information may include speed information of the object 310, distance between the object 310 and the vehicle 105, or visual representations of the proximity information. For example, a distance between the object 310 and the vehicle 105 may be represented by a color coded directional arrow, an arrow of different lengths, or the like.

At step 525 of the process, the augmented image is displayed on the display 150. The augmented image may include objects 310, the superimposed representations of the objects 310, or other elements configured to be displayed on the display 150 as previously described. The process proceeds to step 530, where the controller determines if a proximity between an object 310 in the blind spot 205 has exceeded a proximity threshold. The proximity threshold may include a distance of between 10 centimeters and 5 meters. If the object 310 has not exceeded the proximity threshold, the process returns to step 505 where the vehicle is operating. However, if the proximity threshold has been exceeded, the process continues to step 535 where the controller 115 is configured to control an aspect of the vehicle. The controller 115 may generate a warning, output by the input/output interface 125, alerting a driver of the vehicle that the trailer 110 and the object 310 are in danger of colliding. For example, the display 150 may include a proximity alarm indicating that an object 310 within a blind spot has exceeded the proximity threshold. In some instances, the controller 115 may control the brakes of the vehicle to slow down, stop, control steering within the lane, or otherwise avoid a collision of the trailer 110 with the object 310. In some examples, there are multiple proximity thresholds. For instance, there may be a first proximity threshold, which when exceeded produces an alert for the driver, and a second proximity threshold that is different than the first proximity threshold, which when exceeded causes the controller to control the vehicle. In some instances, the second proximity threshold is a closer distance between the obstacle and the trailer than the first proximity threshold.

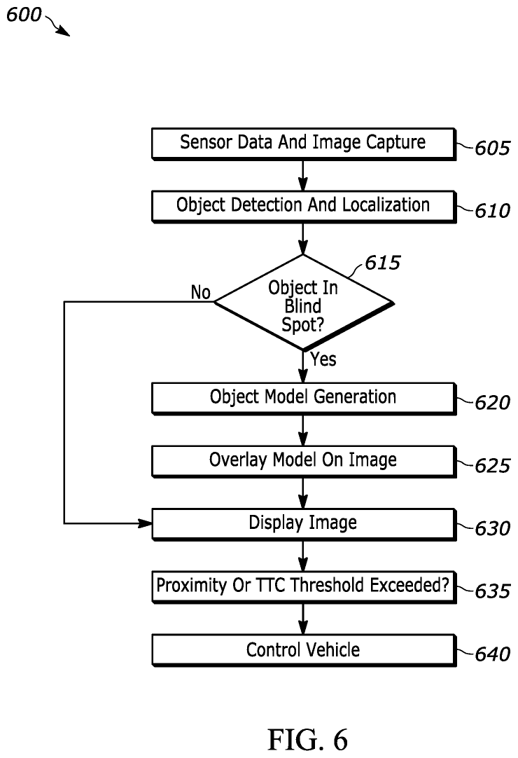

FIG. 6 is a flowchart of a process 600 for monitoring trailer blind spots. Similar to the previously described process 500, the process 600 includes the vehicle 105 towing the trailer 110. The process begins with step 605, where the sensors 140 captures radar data 305, and the camera (145, 275, 280) records an image 410. Similar to process 500, in some instances, radar data 305 may include radar spectral data in addition to location data, and the relative speed of the vehicle may be detected by the sensors 140. At step 610 of the process 600, the image 410 and the radar data 305 are analyzed using object detection and object localization techniques. In some instances, object detection refers to the process of identifying one or more objects 310 within the image 410 and classifying them (such as “car”, “person”, or “tree”). This step may be performed by the algorithm 135 or may be performed by another machine learning technique that is trained on large datasets of labeled images. In some examples, object detection may use a variety of techniques, such as sliding windows, region-based convolutional neural networks (R-CNN), or single-shot detectors (SSD), to locate objects 310 within the image 410.

Object localization, on the other hand, involves not only identifying the presence of the object 310 in the image 410, but also identifying its location within the image 410. This step may be also performed by the algorithm 135, but may also be performed by is defining a bounding box around the object 310, which is a rectangular region that tightly encloses the object 310. The coordinates of the bounding box can then be used to precisely locate the object 310 within the image 410. The process 600 continues with step 615, where the electronic processor 120 determines if the object 310 is within a blind spot (205, 295). If the electronic processor 120 determines that the object 310 is not within the blind spot (205, 295), the image 410 is displayed on the display 150 as described in step 630. On the other hand, if the electronic processor 120 determines that the object 310 is within the blind spot (205, 295), the process continues to step 620, where the object model is generated.

As previously described, the object model is a representation of the object 310 or a group of related objects. In some instances, the object detection and object localization is trained to recognize and locate specific objects within images or video streams. This training may involve a large dataset of images, where each image includes metadata such as the location, size, dimensions, vector, or other properties of the object 310. The object model may learn to recognize and differentiate the features of the object 310 from the background and other objects in the image 410. In some instances, the training of the object model is a part of the process 600. In other instances, the training of the object model is performed prior to the process 600, and then used during the process 600.

The process continues with step 625, where the object model is overlayed on the image 410. As previously described, the overlayed model may be generated based upon previous image captures from the cameras (145, 275, 280), or may be a previously generated 3D model based upon the object 310 classification. Once the object model is overlayed onto the image 410, the image is displayed on the display 150 at step 630. Images displayed on the display may include multiple objects, or partially augmented objects. For example, if the object 310 is partially within a blind spot (205, 295) but partially detected by the sensors 140 or cameras (145, 275, 280), the object 310 may only be partially augmented when displayed. The process continues to step 635, where the electronic processor analyzes the sensor data gathered by the sensors 140 to determine if the object 310 has exceeded a proximity threshold. The electronic processor may additionally or alternatively analyzes the sensor data to determine if the object 310 has exceeded a time to collision (TTC) threshold. If the electronic processor determines that the object 310 has exceeded a proximity threshold, the electronic processor proceeds to control the vehicle 105, in step 640. The electronic processor may control a brake of the vehicle 105, an acceleration of the vehicle 105, a steering of the vehicle 105, or any other method of vehicle control. Additionally or alternatively, the electronic processor may control the display 150 to warn the driver of the vehicle 105 that the threshold has been exceeded.

Accordingly, various implementations of the systems and methods described herein provide, among other things, techniques for detecting and monitoring vehicle blind spots. Other features and advantages of the invention are set forth in the following claims.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

What is claimed is:

1. A system of object detection for a trailer connected to a vehicle, the system comprising:
a camera positioned at a rear end of the vehicle, the camera configured to capture images of the trailer, the images including an object other than the trailer;
a sensor configured to capture sensor data about the object,
a display configured to display images from the perspective of the camera,
a controller on the vehicle, the controller including an input/output interface, a memory, and an electronic processor configured to:
receive the image data from the camera,
receive the sensor data from the sensor,
determine a blind spot,
analyze the sensor data for radar data associated with the object,
calculate the position of the object relative to the blind spot,
determine that the object is within the blind spot using an object detection algorithm, and
in response to the determination that the object is within the blind spot, generate an augmented image including a representation of the object for presentation by the display.

2. The system of claim 1, wherein the augmented image includes proximity information of the object relative to the trailer.

3. The system of claim 1, wherein the augmented image includes a visual representation of the blind spot.

4. The system of claim 1, wherein the augmented image includes more than one blind spot.

5. The system of claim 1, wherein the augmented images include more than one object other than the trailer.

6. The system of claim 1, wherein the sensor is configured to capture sensor data about more than one object.

7. The system of claim 5, wherein the electronic processor is further configured to calculate the position of the more than one object relative to the blind spot and the trailer, and determine that one of the more than one object is within the blind spot using the object detection algorithm.

8. The system of claim 6, wherein the electronic processor is further configured to analyze the sensor data for radar data associated with the more than one object and calculate the position of all of the more than one object relative to the blind spot and the trailer.

9. The system of claim 7, wherein the electronic processor is further configured to generate an augmented image including the more than one object for presentation by the display.

10. The system of claim 8, wherein the electronic processor is further configured to generate an augmented image including all of the more than one object for presentation by the display.

11. The system of claim 8, wherein the electronic processor is further configured to generate an augmented image including proximity information for the more than one object for presentation by the display.

12. The system of claim 8, wherein the electronic processor is further configured to generate an augmented image including the more than one object and more than one blind spot.

13. A method of object detection for a trailer connected to a vehicle, the method comprising:
generating, via a camera positioned at a rear end of the vehicle, images of the trailer, the images including an object other than the trailer;
generating, via a sensor, sensor data about the object,
receiving, via an electronic processor, the image data,
receiving, via the electronic processor, the sensor data,
analyzing, via the electronic processor, the sensor data for radar data associated with the object,
determining, via the electronic processor, a blind spot,
calculating, via the electronic processor, the position of the object relative to the blind spot and the trailer,
determining, via the electronic processor, that the object is within the blind spot using an object detection algorithm, and
in response to determining that the object is within the blind spot, generating, via the electronic processor, an augmented image including a representation of the object for presentation by the display.

14. The method of claim 13, wherein the augmented image includes more than one blind spot.

15. The method of claim 13, wherein the augmented images include more than one object other than the trailer, and the sensor is configured to capture sensor data about the more than one object.

16. The method of claim 15, wherein the method further comprises calculating, via the electronic processor, the position of the more than one object relative to the blind spot and the trailer, and determining, via the electronic processor, that one of the more than one object is within the blind spot using the object detection algorithm.

17. The method of claim 15, wherein the method further comprises analyzing, via the electronic processor, the sensor data for radar data associated with the more than one object and calculating, via the electronic processor, the position of all of the more than one object relative to the blind spot and the trailer.

18. A system of object detection for a trailer connected to a vehicle, the system comprising:
a camera positioned at a rear end of the vehicle, the camera configured to capture images of the trailer, the images including an object other than the trailer;
a sensor configured to capture sensor data about the object, the sensor data including a proximity of the object to the trailer,
a display configured to display images from the perspective of the camera,
a controller on the vehicle, the controller including an input/output interface, a memory, and an electronic processor configured to:
receive the image data from the camera,
receive the sensor data from the sensor,
determine a blind spot,
analyze the sensor data for radar data associated with the object,
calculate the position of the object relative to the blind spot and the trailer,
determine that the object is within the blind spot using an object detection algorithm,
determine if the object has exceeded a proximity threshold, and
wherein response to the determination that the object is within the blind spot, generate an augmented image including a representation of the object for presentation via the display, and
wherein response to the determination that the object has exceeded a proximity threshold, controlling an aspect of the vehicle.

19. The system of claim 18, wherein response to the determination that the object has exceeded a proximity threshold, the controller displays a proximity alarm on the display.

20. The system of claim 18, wherein response to the determination that the object has exceeded a proximity threshold, the controller controls brakes of the vehicle.
